(19) United States
(12) Patent Application Publication
(10) Pub. No.: US 2007/0198549 A1
(43) Pub. Date: Aug. 23, 2007

(54) DATA ENTRY SYSTEMS AND METHODS

(75) Inventors: Bassem Hamdy, Toronto (CA); Gord Rawlins, Newmarket (CA); Lewis Choo Man, Toronto (CA)

Correspondence Address: BERESKIN AND PARR, 40 KING STREET WEST, BOX 401, TORONTO, ON, M5H 3Y2, US

(73) Assignee: COMPUTER METHODS INTERNATIONAL CORP., Toronto (CA)

(21) Appl. No.: 11/608,493

(22) Filed: Dec. 8, 2006

Related U.S. Application Data
(60) Provisional application No. 60/772,869, filed on Feb. 14, 2006.

(51) Int. Cl. G06F 7/00

(52) U.S. Cl. 707/100

(57) ABSTRACT

The present invention is directed to systems and methods for entering data into a database configured to store a plurality of database records, each record having a set of predetermined data fields. The method includes the steps of: (a) creating a data entry message, wherein the data entry message includes at least one data segment, each data segment having (i) a data field identifier corresponding to a data field selected from the set of predetermined data fields, and (ii) a data field entry; (b) sending the data entry message over a communications network; (c) receiving the data entry message; (d) creating a new database record having a plurality of data fields corresponding to the set of predetermined data fields; and (e) for each data segment, storing the data field entry in a data field corresponding to the data field identifier.

### PRIORITY

This application claims priority from U.S. Patent Application No. 60/772,869 filed Feb. 14, 2006, which is incorporated herein by reference in its entirety.

### FIELD OF THE INVENTION

The present technology relates generally to the field of database management systems and data entry.

### BACKGROUND OF THE INVENTION

Businesses typically require the creation and population of databases with data relevant to serving their customers. Data entry into a database typically requires access to the database management system (DBMS) either live or through batch processing.

However, the inventors have recognized that it is not always desirable or possible to provide direct access to the database management system for data entry purposes.

Accordingly, the inventors have recognized a need for an improved data entry system.

### SUMMARY OF THE INVENTION

In one aspect, the subject invention is directed toward a method of entering data into a database configured to store a plurality of database records, each record having a set of predetermined data fields. The method comprises the steps of:
(a) creating a data entry message, wherein the data entry message includes at least one data segment, each data segment including:
   i. a data field identifier corresponding to a data field selected from the set of predetermined data fields; and
   ii. a data field entry;
(b) sending the data entry message over a communications network;
(c) receiving the data entry message;
(d) creating a new database record having a plurality of data fields corresponding to the set of predetermined data fields; and
(e) for each data segment, storing the data field entry in a data field corresponding to the data field identifier.

As will be understood, the data entry message may comprise an email message, although other forms of data communication may also be used.

In another aspect, the invention is directed towards a method of processing a data entry message containing at least one data segment having a data field identifier selected from a set of predetermined data fields and a data field entry. The method comprises the steps of:
(a) creating a new database record having a plurality of data fields corresponding to the set of predetermined data fields; and
(b) for each data segment, storing the data field entry in a data field corresponding to the data field identifier.

In yet a further aspect, the subject invention is directed towards a data entry system having an input device configured to determine a data field identifier and to input a corresponding data field entry, and a message generator operatively coupled to the input device and configured to create a data entry message. The data entry message is provided with at least one data segment, and each data segment includes a data field identifier corresponding to a data field selected from the set of predetermined data fields together with a data field entry. The system includes a message transmitter operatively coupled to and configured to send the data entry message over, a communications network, a receiver operatively coupled to the communications network and configured to receive the data entry message. The system also includes a message manager operatively coupled to the receiver and configured to retrieve from the data entry message the data field identifier and data field entry for each segment and a database including a new database record having a plurality of data fields corresponding to a set of predetermined data fields. The system is further provided with a database manager operatively coupled to the message manager and to the database and configured to, for each data segment, store in the database record the data field entry in a data field corresponding to the data field identifier.

In another aspect, the invention is directed towards a data entry system comprising a receiver operatively coupled to the communications network and configured to receive a data entry message and a message manager operatively coupled to the receiver and configured to detect at least one data field identifier and corresponding data field entry in the data entry message.

### BRIEF DESCRIPTION OF THE DRAWINGS

The present invention will now be described, by way of example only, with reference to the following drawings, in which like reference numerals refer to like parts and in which:

FIG. 1 is a schematic diagram of a data entry system made in accordance with the present invention.

FIG. 2 is a schematic screen shot diagram of example client records data, as may be stored in a clients database of the data entry system of FIG. 1;

FIG. 3 is a schematic screen shot diagram of example issue records data, as may be stored in an issue database of the data entry system of FIG. 1;

FIG. 4 is a flow diagram illustrating the steps of a method carried out by the data entry system of FIG. 1;

FIG. 5A is a schematic screen shot diagram of an example introductory data entry message, as may be generated by the data entry system of FIG. 1;

FIG. 5B is a schematic screen shot diagram illustrating the creation of the example introductory data entry message of FIG. 5A;

FIG. 6 is a flow diagram illustrating the steps of a method carried out by the data entry system of FIG. 1 when data is to be entered into the data storage;

FIG. 7 is a schematic screen shot diagram of an example data entry message, as may be processed by the data entry system of FIG. 1;

FIG. 8 is a schematic screen shot diagram of an example confirmatory data entry message, as may be processed by the data entry system of FIG. 1;

FIG. 9 is a schematic screen shot diagram of an example data entry message for update mode, as may be processed by the data entry system of FIG. 1; and

FIG. 10 is a schematic screen shot diagram of the example issue records data of FIG. 3, updated with a note entry.

### DETAILED DESCRIPTION OF THE INVENTION

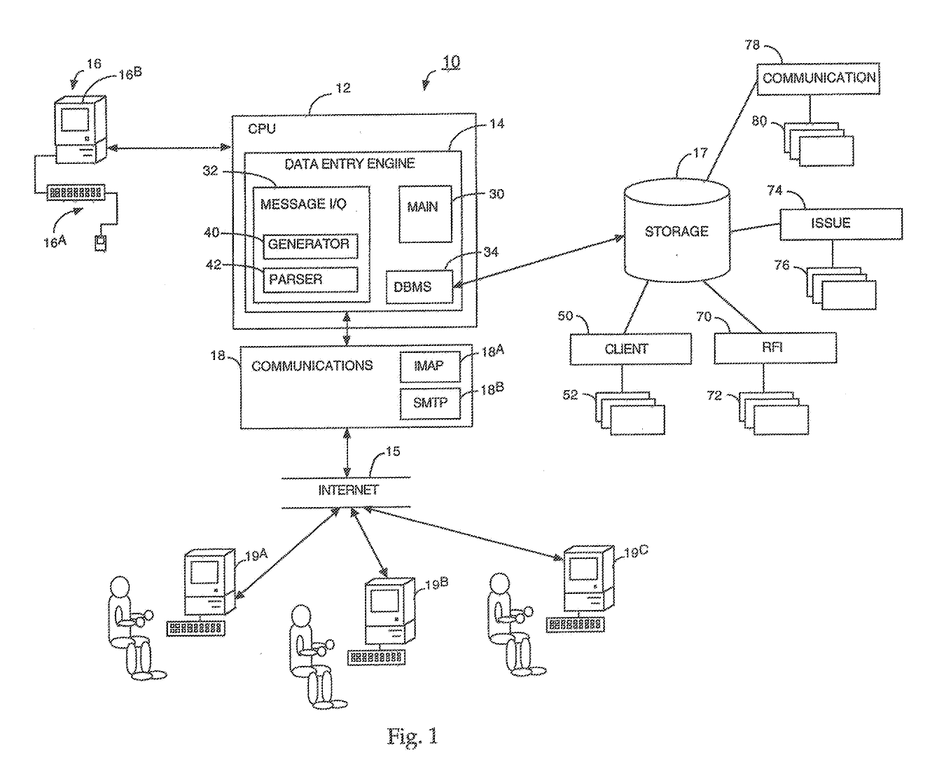

Referring to FIG. 1, illustrated therein is a data entry system, referred to generally as 10, made in accordance with the present invention. The data entry system 10 comprises a processor or central processing unit (CPU) 12 such as a standard personal computer (PC) running on a WINDOWS™ operating system and having a suitably programmed data entry system engine 14, although as will be understood, other hardware and processing configurations are possible. At least one input/output device 16 (typically including one or more input components 16^{A} such as a keyboard, and one or more output components such as a display 16^{B}) are also operatively coupled to the CPU 12. Data storage 17 is also provided—this data storage 17 may be local such as on a hard drive coupled to the CPU 12, or it may be remote networked data storage, as will be understood.

The system 10 is also provided with a communications module 18, operatively coupled to both the CPU 12 and to the internet 15 or other communications network for the exchange of data. Typically, the communications module 18 will include both an IMAP mail server 18^{A} and an SMTP mail server 18^{B}, as will be understood.

A plurality of data entry devices 19^{A}, 19^{B}, and 19^{C} operatively coupled to the communications network 15 may interact with the system engine 14. These devices 19^{A}, 19^{B}, and 19^{C} are configured to be able to create and send and receive data messages, typically in the form of email messages, and as such may be suitably programmed PCs or PDAs (personal digital assistant). In the example, three data entry devices 19^{A}, 19^{B}, and 19^{C} are illustrated—however, as will be understood, any device capable of generating and receiving data messages such as email messages as utilized by the system 10, may function as a data entry device, and hence any number of devices may be used.

The data entry system engine 14 may be implemented in JAVA, although other programming languages may be used, and the engine 14 may include several modules. A main executable module 30 is preferably provided for controlling the operation of two sub-modules: a message I/O processor 32 and a database manager 34. The main module 30 controls the interfacing between the input/output device 16 and each of the sub-modules 32, 34.

The message I/O processor 32 is configured to send and receive data messages via the communications module 18, as will be discussed in greater detail below. The message I/O processor 32 is typically provided with a message generator module 40 and a parser module 42. The message I/O processor 32 may be implemented on a single server, or on multiple servers depending on the volume of data to be processed. The database manager 34 is configured to store data in and retrieve data from the data storage 17. The database manager 34 may be implemented, for example, using ORACLE™.

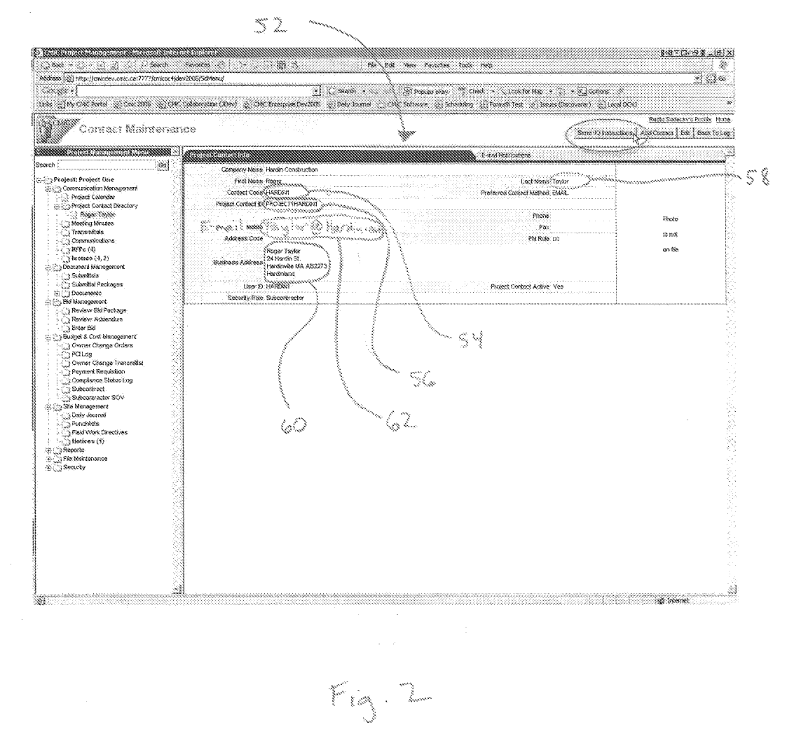

Different types of data records may be stored in the data storage 17, as will be understood. A client or project database 50 may contain client or project records 52 stored in the data storage 17. Referring now to FIG. 2, illustrated therein is an example of the type of client records 52 data typically stored in the client database 50. Typically the client records 52 data will be determined and input into the database 50 by a system user via the I/O device 16, when a new client is received by the system 10 owners or when a new project is initiated.

Each client record 52 will typically include unique identifier data such as unique client identifier data 54 and/or unique project identifier data 56. The client record 52 will also typically include contact name 58 and mail address and other contact information 60 data. An email or other communication network address 62 will also be provided.

The data storage 17 will also store one or more object databases into which the system 10 is configured to enter data during operation. For example, an RFI (request for information) database 70 storing RFI records 72, an issue database 74 storing issue data records 76, and a communication database 78 storing communication data records 80, may be provided. As will be understood, however, the number and type of object databases stored in the data storage will vary depending on the application and data to be stored and managed by the system 10. Each type of object database record 72, 76, 80 will typically have a unique combination or set of predetermined data fields relevant to the intended purpose or function of the corresponding databases 70, 74, 78, as will be understood.

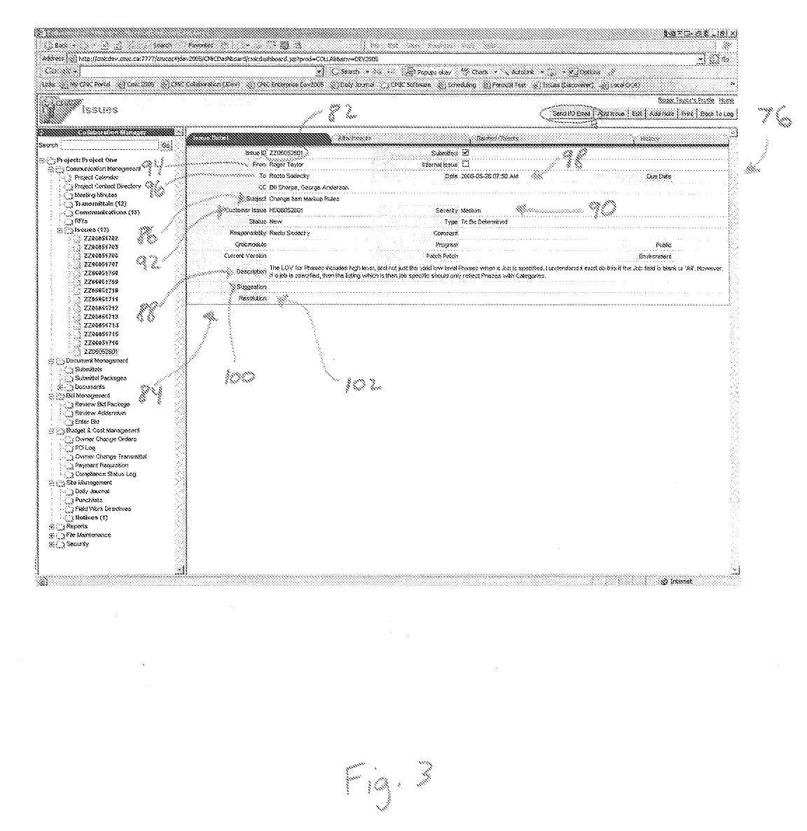

Turning now to FIG. 3, illustrated therein is an example of the type of issue record 76 data which may be stored in the issue database 74. The issue record 76 will typically include a unique object identifier 82 (specifically an issue identifier in the example of an issue record 76), as well as data entry fields 84 such as subject 86, description 88, severity 90, and customer issue 92. As will be described in greater detail below, the data to populate the data entry fields 84 is intended to be entered into the system's 10 data storage 17 by users using a data entry device 19^{A}, 19^{B}, and 19^{C}. The issue records 76 may also be provided with sender 94 and recipient 96 fields, together with a date field 98, and suggestion 100 and resolution 102 fields. Additional or different fields may also be provided.

In order to better understand the example databases 70, 74, 78, the following exemplary tables illustrate the parameters of a possible implementation of databases 70, 74, 78 and their corresponding data records 72, 76, 80.

TABLE 1
Features of Object Databases

| | | | |
|---|---|---|---|
| Object Types | Main Operation | Notes | Attachments |

Insert Mode

| | | | |
|---|---|---|---|
| RFI | Inserts a new RFI | x | ✓ |
| | record | | |
| Issue | Inserts a new Issue | x | ✓ |
| | record | | |
| Communications | Inserts a new | x | ✓ |
| Log | Communications Log | | |
| | record | | |

Update Mode

| | | | |
|---|---|---|---|
| RFI | Updates Reply Field | Creates a new | ✓ |
| | is RFI is not yet | Note record | |
| | | only if | |
| | answered | RFI is already | |
| | | answered | |
| Issue | N/A | ✓ | ✓ |
| Communications | N/A | ✓ | ✓ |
| Log | | | |

TABLE 2
Valid Field Names in Insert Mode

| | Valid Field | |
|---|---|---|
| Object Type | Names in Email | Default Values |
| RFI | Subject | Pseudo-field email subject line, if |
| | | not null else 1^{st} 197 chars of the |
| | | Question plus ellipsis ( . . . ) |
| | Date Required | N/A |
| | Cost Impact | P |
| | Question | Pseudo-field email body |
| | Suggestion | N/A |
| Issue | Subject | Pseudo-field email subject line, if |
| | | not null else 1^{st} 57 chars of the |
| | | Description plus ellipsis ( . . . ) |
| | Customer Issue | N/A |
| | Severity | 1^{st} priority code with priority level |
| | | 3 (Medium) |
| | Description | Pseudo-field email body |
| Communications | Subject | Pseudo-field email subject line, if |
| Log | | not null else 1^{st} 197 chars of the |
| | | Message plus ellipsis ( . . . ) |
| | Message | Pseudo-field email body |

TABLE 3
Valid Field Names in Update Mode

| | Valid Field Names | |
|---|---|---|
| Object Type | in Email | Default Values |
| RFI | N/A | N/A |
| Issue | N/A | N/A |
| Communications | N/A | N/A |
| Log | | |

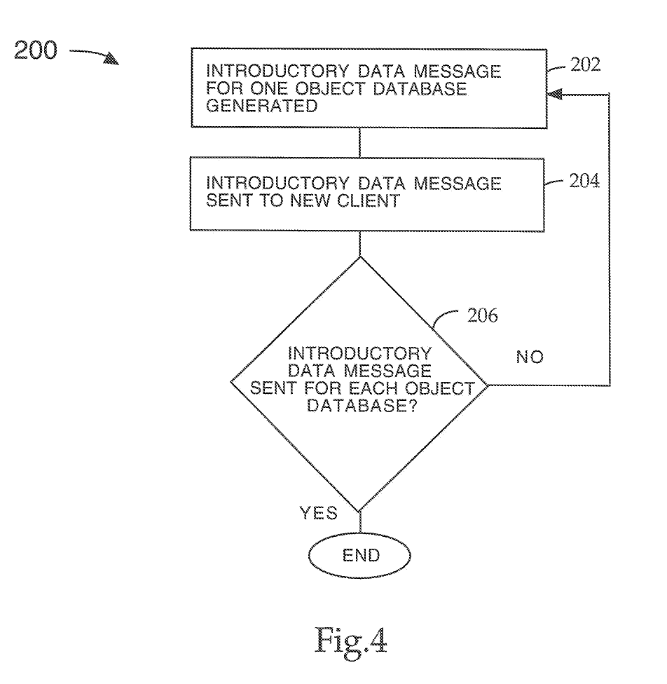

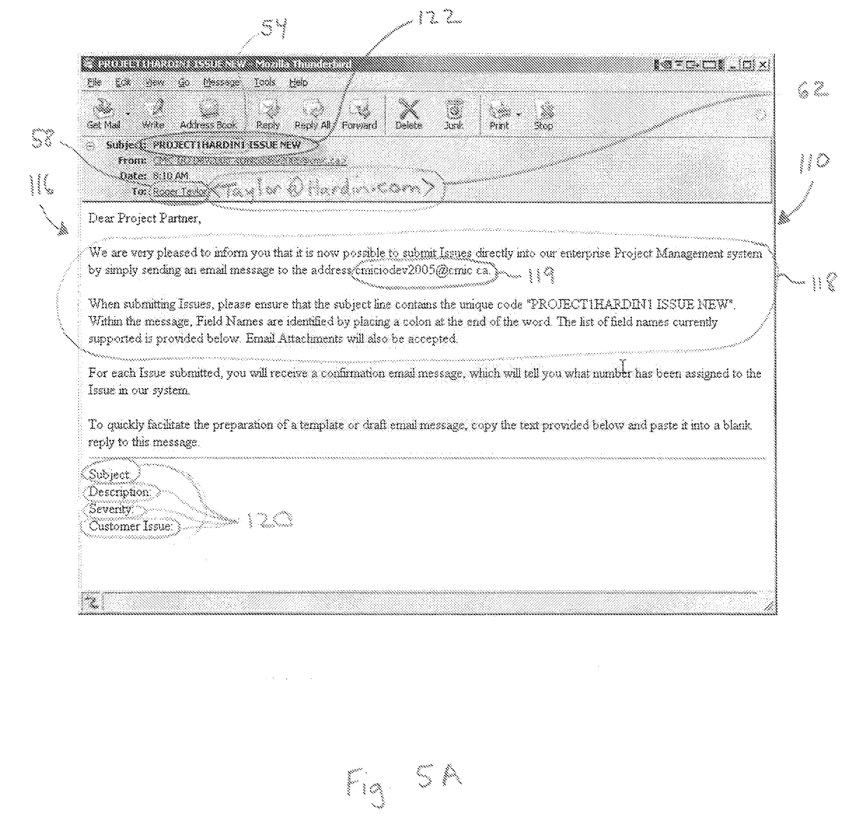

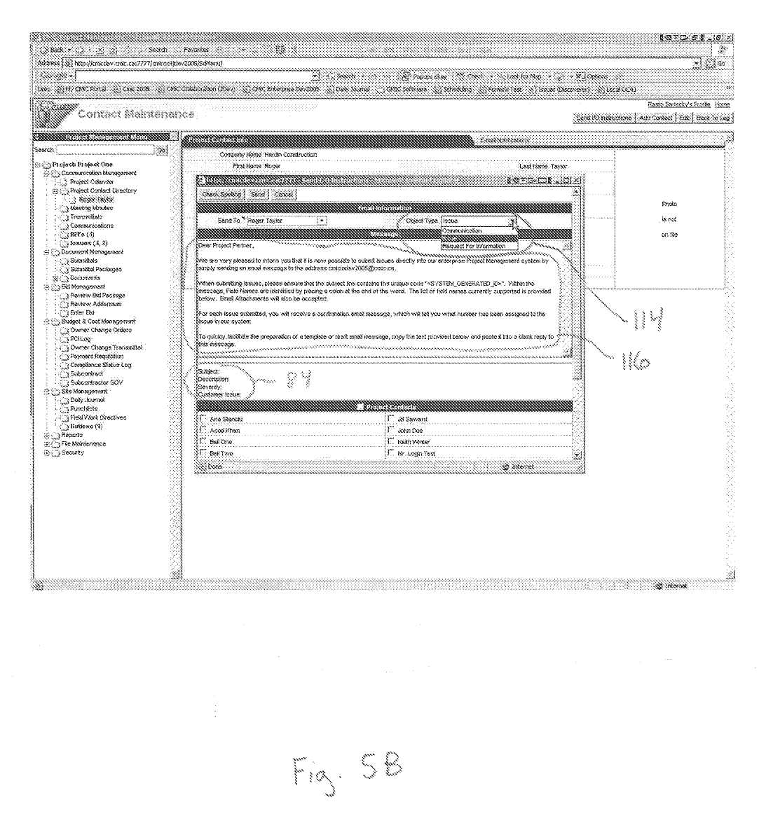

Referring now to FIG. 4, this figure is a flow chart setting out a process 200 carried out by the message generator module 40. Typically, when a new client is added (and a new client record 52 is created and stored in the client database 50), a user will (using an I/O device 16) activate the message generator module 40. The message generator module 40 is configured to enable the user to generate an introductory data message 110 (as illustrated, for example in FIG. 5A) (Block 202).

As will be understood, the user selects the particular client record 52 corresponding to the new client, and the message generator module 40 retrieves the email address 62 and contact name 58 from the client record 52, and corresponding addressee information 112 is added to the data message 110. As indicated in FIG. 5B, the user also selects the type 114 of introductory data message 110, which types 114 typically correspond to the different types of object database records 72, 76, 80. Preferably, a previously-stored message body 116 corresponding to the selected type 114 is added to the data message 110. The message body 116 will typically include instructions 118 for entering data into the system 10 (including the system email address 119 to direct emails for receipt by the communications module 18), together with data field identifiers 120 corresponding to the data fields (such as data entry fields 84 for an “issue”) for the selected type 114.

As will be discussed in greater detail, below, the message generator module 40 also creates a key 122 which is included in the introductory data message 110 subject line.

A user-readable key 122 in the email subject line may uniquely identify the database 70, 74, 78 and database record 72, 76, 80 to insert/update. The user-readable key 122 will typically be created to satisfy the following conditions:
1. Identify the project 56
2. Identify the contact 54
3. Identify the object type—ie. identify the target database 70, 74, 78
4. Identify the target database record 72, 76, 80, for updates and adding detail records such as Notes
5. Identify the data entry mode—insert or update (which will be discussed in greater detail, below)

The requirements 1 and 2 above may be implemented by defining a new field Proj_Contact_ID in a lookup table to uniquely identify a project 56 and contact 54 combination. This new field has to be maintained before the system may be used. Since, the Object Id is usually unique with a project or company (derivable from the project) and in insert mode no target record needs to be identified, requirements 4 and 5 above are implemented with the Object Id for updates and the keyword “NEW” for inserts. Hence, the format of the key 122 may be as follows:

ProjectContactID ObjectType NEW in Insert mode

ProjectContactID ObjectType ObjectId in Update mode

TABLE 4
Examples of Keys 122:

| Key | Description |
|---|---|
| PROJ1XX RFI NEW | Key to create a new RFI for project and contact |
| | identified by PROJ1XX |
| PROJ1XX ISSUE | Key to update/add notes to Issue ZZ0123 for |
| ZZ0123 | project and contact identified by PROJ1XX |

Once the introductory data message 110 has been generated, it is sent to the email address corresponding to the contact information 112, via the communications module 18 (typically using the SMTP mail server 18^{B}) over the internet 15 (Block 204). As will be understood from the discussion which follows, the key 122 and data field identifiers 120 in the introductory data message 110 function as a template which the recipient can later use to enter data into the data storage 17. Accordingly, a different introductory data message 110 will typically be generated and sent to the new client for each type of object database 70, 74, 78 in the data storage 17 (Block 206).

Messages to be generated by the message generator module 40 containing standard form text such as the previously-stored message body 116, may be hard-coded in programs. Alternatively, to facilitate maintenance, Form Letter styles of templates may be maintained in database tables with the fields being substituted with appropriate values during the generation of the email subject and body.

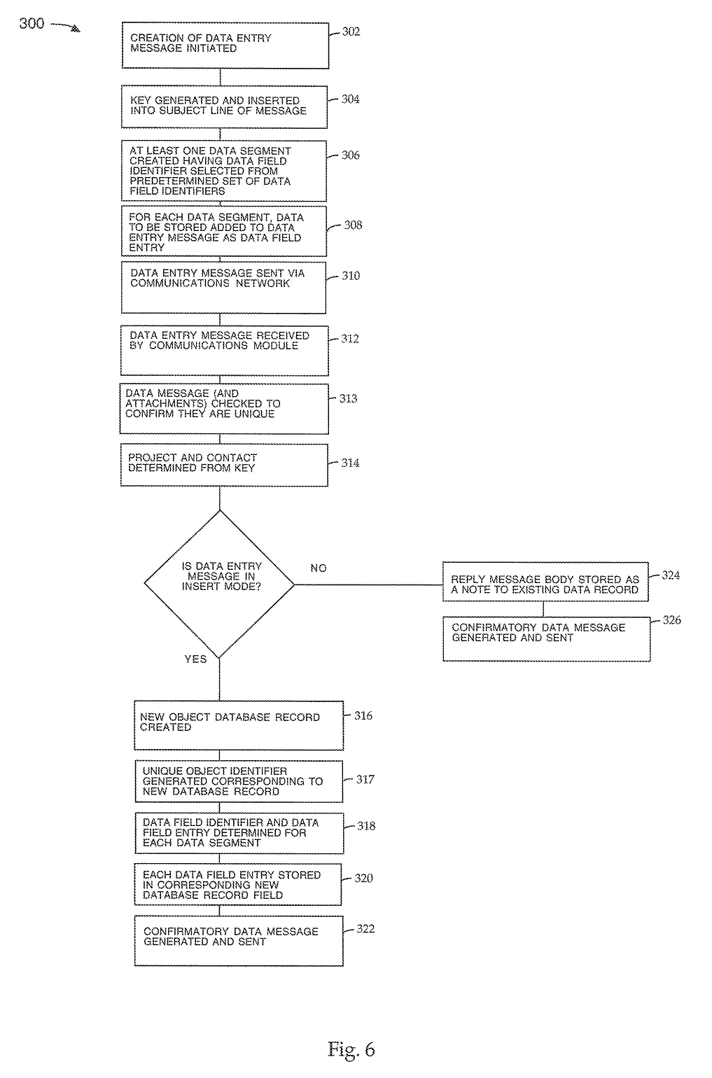

Referring now to FIG. 6, this figure is a flow chart setting out a process 300 carried out by the system 10 when data is to be entered into the data storage 17.

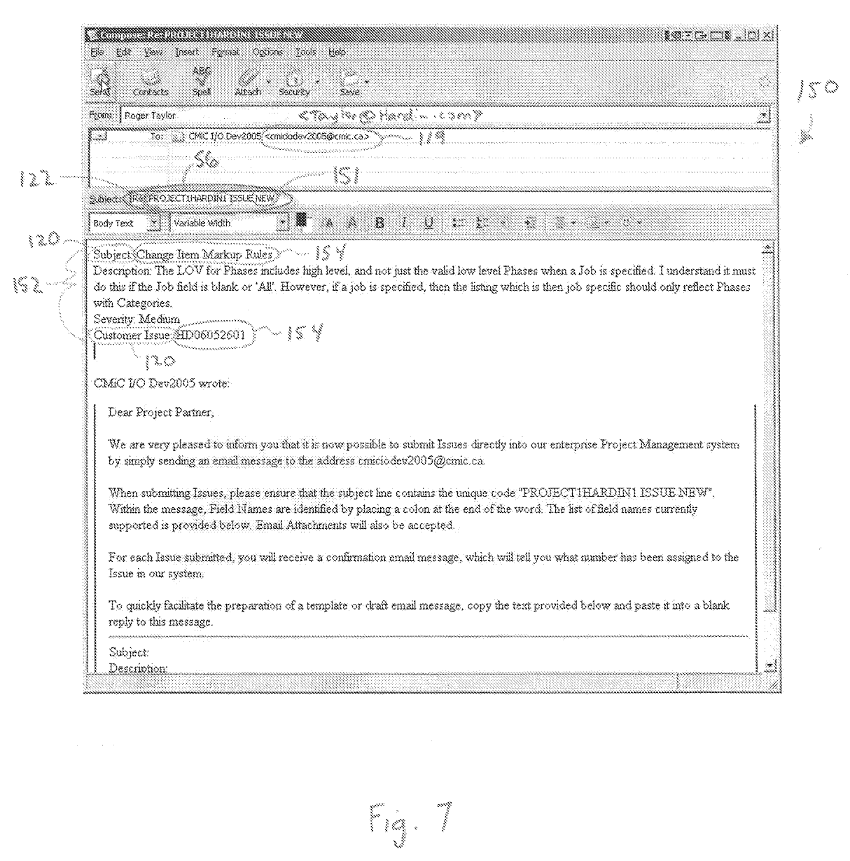

Using a data entry device 19^{A}, 19^{B}, 19^{C}, a client or other individual may commence the creation of an entry data message 150 (as illustrated for example, in FIG. 7) for the purpose of entering data into the data storage 17 (Block 302). Typically, the client will initiate a reply email to an introductory data message 110, which can be used as a template for data entry, or alternatively, the client may also manually enter the relevant key data and addressee data.

The subject line of the data entry message 150 is provided with the key 122 which may have been copied from the introductory data message 110 corresponding to the object database 70, 74, 78 that the client wishes to enter data into or update (Block 304). As discussed in greater detail, above, the key 122 uniquely identifies the object database 70, 74, 78 and database record 72, 76, 80 to insert/update. The key 122 also may contain mode data 151 (which may be an object identifier 82) indicating whether or not the data is intended to be inserted into a new data record (insert mode) or added to an existing data record (update mode). The mode data 151 “NEW”, in the example data message 150 indicates that the data is to be inserted into a new data record in insert mode. The data message 150 is also provided with the system email address 119 to direct emails for receipt by the communications module 18.

The data message 150 is also provided with at least one data segment 152 having a data field identifier 120 from the predetermined set corresponding to the data fields (such as data entry fields 84 for an “issue”) for which the client wishes to enter data (Block 306). The client also inputs one or more data field entries 154 (which form part of the data segment 152) corresponding to the data field identifier 120 and containing the data to be stored in the data storage 17 (Block 308).

The following guidelines and approach of the present exemplary implementation may be adopted for generating a data segment 152 in a data message 150:
1. The new field name (or data field identifier 120) starts on a new line with a valid field name for the object type and is terminated by a field terminator, such as a colon (:).
2. The field value (or data field entry 154) starts right after the field terminator and may span across multiple lines. The field value 154 stops when (i) the next field name 120 starts, or (ii) the end of the email message is reached, or (iii) the original message starts (if it is included in a reply email message).
3. If the field value 154 spans across multiple lines and one of the subsequent lines may be ambiguously confused with a field name 120, that line or the whole of the field value 154 should be enclosed between a pair of field value delimiters, such as a quotation mark (“).
4. If one field value delimiter character is to be specified as a value it should be enclosed by a pair of field value delimiters and specified as double characters.

Once the data message 150 has been created by the client, it is sent by the data entry device 19^{A}, 19^{B}, 19^{C} via the internet 15 (Block 310) and received by the communications module 18 (Block 312). The communications module 18 may then check the data message 150 to confirm that the message 150 (and any attachment) is unique and has not previously been received and processed (Block 313).

As will be understood, if the communications module 14 is configured to uniquely identify each email message (such as data message 150), multiple processes may not process the same email message thereby avoiding processing errors. Similarly, when email attachments are being saved for a particular object, it makes no sense to save the same attachment file multiple times especially when the attachment names are identical. However, in the real world, different emails may be sent with attachments that already exist for the object and as a result, attachments may be uniquely identified to eliminate duplicates.

One possible way to test for duplicates is to compare the input streams of two email messages, including the attachments in the email message. The same reasoning applies for attachment files. However, there are problems associated with those approaches. In the case of email messages, the whole email message would have to be stored in BLOB or BFILE columns in a database session table to verify that it has not already been processed. The dbms_lob supplied PL/SQL package does allow comparisons on BLOB and BFILE columns, but those columns may not be indexed. And since, the database session table stores a history of processed email messages and could potentially contain thousands, if not millions of rows, this would result in a very inefficient search, especially when each BLOB/BFILE column may contain kilobytes or megabytes (or more) of data.

In the case of attachments, the comparison may be done outside the database, in the file system because that is where attachments are typically stored. However, here again a performance issue arises as high numbers of comparisons may be required.

An alternate approach for comparing emails and attachments involves the use of checksums. The Java 1.4 Standard Library provides two different algorithms to compute 32-bit checksums, namely java.util.zip.Adler32 and java.util.zip.CRC32. Using the 32-bit checksums of the two algorithms together on email messages and attachments effectively yield 64-bit checksums, which is reasonably long to avoid duplicate checksums on different streams of bytes. However, other checksum algorithms can be used if desired.

In the case of email messages, checksums instead of email message contents may sent and stored in the database to ensure that the same email message is not processed more than once. The search on checksums is fast no matter how big the database session table is, because the field has a unique index. In the case of attachments, the comparison is consistently fast because the checksums are stored and searched in Hashtables, which allows high speed searches even if the data set is large.

Referring back to FIG. 6, the parser module 42 then determines the project 56 and contact 54 combination from the key 122 in the subject line of the data entry message 150 (Block 314). The parser module 42 is then configured to determine the mode of the message (Block 315). In the example data message of FIG. 7, the parser module 42 detects mode data 151 “NEW” in the key 122, indicating insert mode.

The following discussion sets out potential obstacles together with various approaches the parser module 42 may be programmed to implement in processing data entry messages 150, 150′.

When replying to an email, different email client software/web-mail use different delimiting lines to distinguish between the reply message and the original message. Some examples of delimiting lines are as follows:

1. John Tester! wrote:
where John Tester! is the personal name of the sender

2. jtester@cmic.ca wrote
where jtester@cmic.ca is the email address of the sender

3. —original message—

4. —original message—
note the space between the dashes and words

As will be understood, there are no universally adopted standards for the delimiting lines in email messages. Another potential parsing difficulty arises from the fact that the reply message may appear above or below the delimiting line, for which again there is no clearly defined standard. The parsing module 42 may be programmed on the assumption that the reply message is always above the delimiting line and any such assumptions or guidelines should be clearly stated in the instructions in the standard form text such as the previously-stored message body 116 of the introductory data message 110.

After applying a reasonable scope to this function, one possible solution is provided in the form of a user-definable list of email addresses and personal names of sender that are used to detect delimiting lines. The rule is that the first line in the email body that contains (case-insensitive) either any personal name or email address in the list marks the end of the reply message, excluding that delimiting line. Any subsequent lines are deemed to be part of the original message and are hence ignored.

The email address should follow the RFC 2822 specification as follows:

TABLE 5
RFC 2822 Specifications

| | | |
|---|---|---|
| alphanum | → | A–Z \| a–z \| 0–9 |
| valid_char | → | ! \| # \| $ \| % \| & \| ” \| * \| + \| − \| / \| = \| ? \| \hat{ } \| _{—} \| \grave{ } \| |
| | | { \| } \| ~ \| \| \| alphanum |
| word | → | (valid_char)+ |
| dot | → | A period |
| email_address | → | word(dot word)*@word(dot word){0, 5} |

The personal name can take any character except for the double quote character (“), but should be at least 10 characters in length to be processed as a valid string in the delimiting line. The personal name can be used to simulate virtually any eligible string to detect the delimiting line, e.g —original message—

In the example below in Table 6, line 6 is the delimiting line since it contains the string —original message— when doing a case-insensitive search and lines 1 to 5 are processed as the reply message, the remaining lines are ignored.

TABLE 6
Example of an email reply message

| Line | Email Reply Message |
|---|---|
| 1 | |
| 2 | Message: Communications Log Message |
| 3 | |
| 4 | Subject: Communications Log Subject |
| 5 | |
| 6 | ----- Original Message ------ |
| 7 | |
| 8 | ---------------------------------------------------------------------------------------------- |
| . | ---------------------------- |
| . | Please ensure that you include the unique key PROJECT1LEWIS |
| . | COMM NEW in the subject line of the emails you send. |
| | ---------------------------------------------------------------------------------------------- |
| | ---------------------------- |
| | Create New Communication Log for project Collaboration Project, |
| | company CMiC Test Company test, and customer Project One Inc. |
| | Please fill in only the fields with a field name ending with a: above this email. |
| | The following field names are allowed: Subject, Message. |
| | Field values may span across several lines, but those lines containing a “ should |
| | be enclosed by a ” on the left and a ” on the right. |
| | Alternatively, reply above this email or create a new one with the email body |
| | being the Message and the portion of the email subject to the right of the unique |
| | key being the Subject. Attachments are also accepted. |

Referring back to FIG. 6, when a message 150 is received designating insert mode, a new object database record 72, 76, 80 (designated by the key 122) is created by the database manager 34 (Block 316), and a unique object identifier 82 is also generated (Block 317). As discussed in greater detail, below, the parser 42 then detects each data field identifier 120 and corresponding data field entry 154 in each of the message's 150 data segments 152 (Block 318).

The following discussion sets out potential obstacles together with various approaches the parser module 42 may be programmed to 10 implement in processing data entry messages 150, 150′ pursuant to Block 318.

Typically, the parsing is carried out line by line. The following regular expressions in Table 7 may be used to detect a field name at the beginning of a line, which marks the beginning of a new field.

TABLE 7

| | | |
|---|---|---|
| field_terminator | → | Defined in |
| | | ioemail_sysopt.iosys_field_name_terminator |
| | | (set out below) |
| field_name | → | \hat{ }>*\s*((\w\s*)+)field_terminator |

As well, the following guidelines and assumptions may be implemented in parsing data messages (although it should be understood that alternate parsing guidelines may also be implemented):
1. A field name always starts at the beginning of a line preceded only by an optional>sign and optional spaces, and ends with the field terminator defined in ioemail_sysopt.iosys_field_name_terminator. The field name should also be valid for the object type being processed.
2. A field name may consist of one or more words separated by spaces, but those words should not include the field name terminator, otherwise the field name would not be properly parsed.
3. The validity of a field name is determined by doing a case-insensitive and space-insensitive match. Space-insensitive means multiple spaces are matched as only one space.
4. A string at the beginning of a line that satisfy the field name regular expression, but is enclosed by a pair of field value delimiters (defined in ioemail_sysopt.iosys_field_value_delimiter) is processed as field value rather than field name.
5. Field values may span across multiple lines and start right after the field name terminator and stop when (i) the next field name starts, or (ii) the end of email message is reached, or (iii) the original message starts
6. The field value delimiter is not parsed as being part of the field value.
7. A field value delimiter is parsed as a constant literal in a field value when it is enclosed by a pair of field value delimiters and is doubled.
8. If a field value delimiter is not paired, the portion of the text after the field value delimiter up to the end of the email message is parsed as one field value.

The following table sets out example field name and value delimiters, as well example valid field names.

TABLE 8
Example Definitions

| | |
|---|---|
| Let ioemail_sysopt.iosys_field_name_terminator = | : |
| Let ioemail_sysopt.iosys_field_value_delimiter = | ” |
| Let valid field names for an object type: = | subject, severity, |
| | customer issue, |
| | description |

The following table sets out various example text and illustrates how a parser 42 programmed to implement the various guidelines noted above would parse the text. Example 1 above shows the use of the field value delimiter (“) and field value spanning across multiple lines. Example 2 shows that when invalid field names are used, they are assigned as field values to the previous field. Example 2 also shows that when a field name terminator (:) appears a second time on a line, it is always unambiguously parsed as a constant literal. Example 3 shows how field value delimiters may be specified as constant literals. Example 4 shows what happens when a field value delimiter is not properly paired.

TABLE 9
Text Parsing Examples

| | | Parsed As | |
|---|---|---|---|
| | Email Body | Field Name | Field Value |
| 1 | Description: This is a test | Description | This is a test description, |
| | description ”, | | Severity: Low |
| | Severity: Low” | Customer | ZZ0123 |
| | Customer Issue: ZZ0123 | Issue | |
| | Subject : Subject Line of | Subject | Subject Line of Issue |
| | Issue | | |
| 2 | Description: A test | Description | A test description: , |
| | description: ”, | | Severity: Low |
| | Severity: Low” | | Customers Issues: |
| | Customers Issues: ZZ0123 | | ZZ0123 |
| | Severity: Low | Severity | Low |
| 3 | Description: A field value | Description | A field value delimiter: “ |
| | delimiter: “”“” | | Multiple field value |
| | Multiple field value | | delimiters ”“” |
| | delimiters “”“”“”“” | | |
| 4 | Description: An “unpaired” | Description | An unpaired field value |
| | field value | | Delimiter takes all text as |
| | Delimiter ”takes all text as | | one field |
| | one field | | Severity: High |
| | Severity: High | | Subject: Subject Line |
| | Subject: Subject Line | | Customer Issue: ZZ0123 |
| | Customer Issue: ZZ0123 | | |

Referring back to FIG. 6, once the parser 42 has parsed the data, each data field entry 154 is then stored in the new record's field corresponding to the data field identifier 120 (Block 320). Referring simultaneously to FIGS. 7 and 3, FIG. 3 illustrates an example issue data record 76 which may be created by the message I/O processor 32 and database manager 34, upon receipt of the example data message 150 in FIG. 7 and execution of Blocks 312-320.

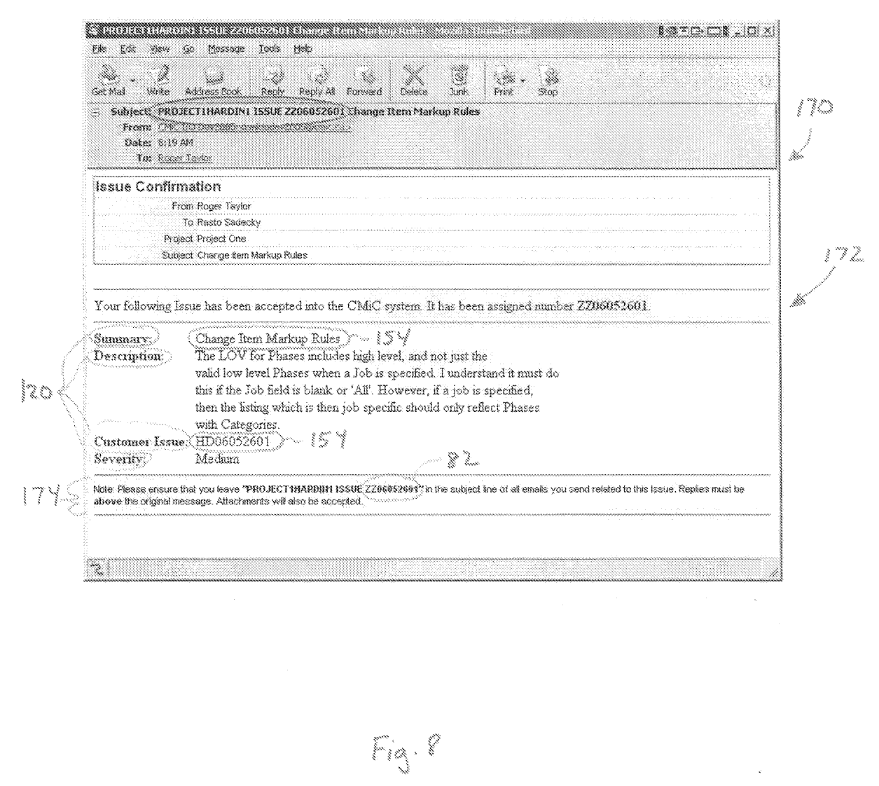

Upon completion of storing the different data field entries 154 into the database record 72, 76, 80, the message generator module 40 is configured to generate and send a confirmatory data message 170 (as illustrated, for example in FIG. 8) (Block 322).

As will be understood, the message generator module 40 retrieves the sender's email address from the data entry message 150 which is added to the confirmatory data message 170. Preferably, a previously-stored message body 172 is added to the data message 170. The message body 172 will typically include a copy of each data field identifier 120 and corresponding data field entry 154 in each of the data entry message's 150 data segments 152 which have been stored in data storage 17. The body 172 will also typically include instructions 174 for subsequent related communications and identifying the object identifier 82 created in Block 317.

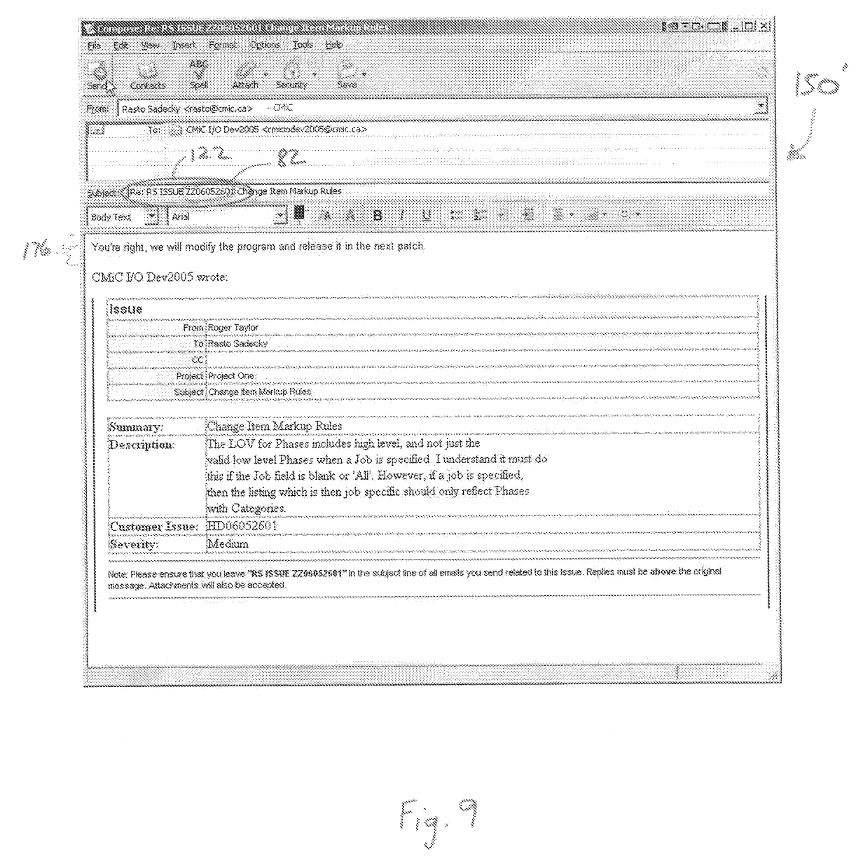

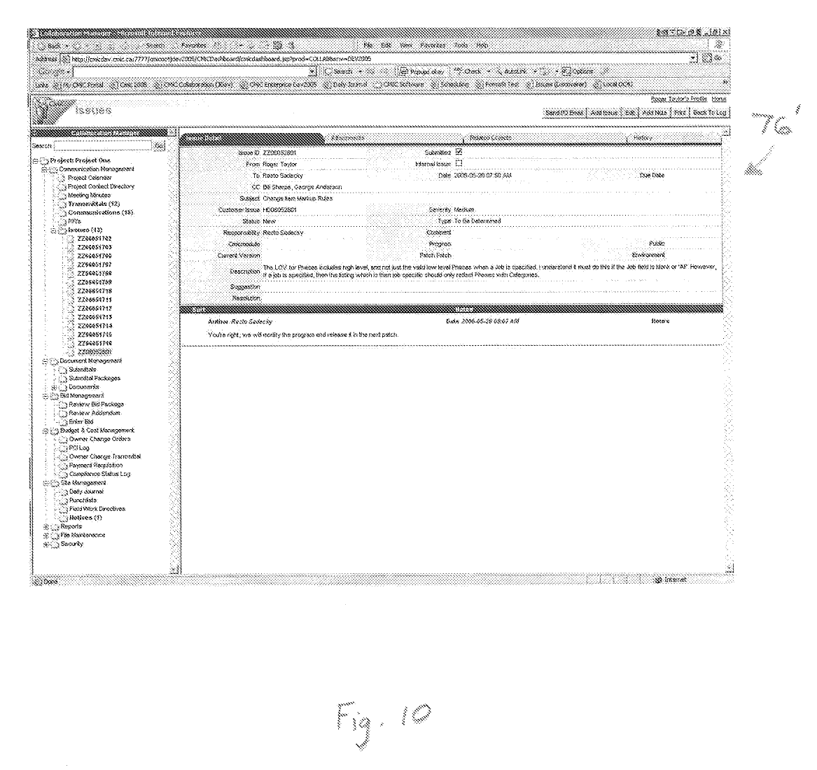

If in Block 315, the parser module 42 detects an object identifier 82 (in the mode data 151) in the key 122, indicating update mode (as illustrated in the example data entry message 150′ illustrated in FIG. 9), the reply message body 176 is stored as a note linked to the corresponding data record 72, 76, 80 (as illustrated in the example updated data issue data record 76′ illustrated in FIG. 10) (Block 324). A confirmatory data message may also be generated and sent indicating that the reply message body 176 has been stored in the data record 72, 76, 80 (Block 326).

Attachments are supported in both Insert and Update modes. This merely involves attaching files to the data entry message 150, 150′, with a valid key 122 in the subject line. In Insert mode, mandatory fields should also be specified in the email body, otherwise no object would be created and the attachments would have no object to associate with. In Update mode, only attachments may be added to the data entry message 150, 150′ with an empty email body, in which case only attachments will be added to the existing object record 72, 76, 80.

As mentioned previously, the message I/O processor 32 may be implemented on multiple servers and each mail message will preferably be uniquely identified and processed by one process at a time. Accordingly, a semaphore can be implemented only on an entity common to all the sessions running the message I/O processor 32. The only common entities are the email server itself and the database. Since an email server does not typically allow any locking mechanism to implement the semaphore, the semaphore may be implemented on the database. The database semaphore may be implemented using the following guidelines:
1. Before each email message is about to be processed, its checksum is inserted into the database session table, with the checksum subject to a database unique constraint. If the checksum did not exist, it is inserted and the email message is processed.
2. If the checksum already existed, there are only four possibilities
   The email message is marked as running and its start date and time has not yet exceeded a predetermined timeout, it is assumed that another session of the program is already processing the email message. Hence, the email message is ignored in the current session.
   The email message has been marked as running and its start date and time has already exceeded the predetermined timeout, it is assumed that the other session of the program processing the email message failed to complete. Hence, the start date time is updated and the email message is re-processed in the current session. This feature allows for re-processing in the case of crashes.
   The email message has been marked as complete and its end date and time has not yet exceeded the predetermined timeout, the email message is ignored.
   The email message has been marked as complete and its end date and time has already exceeded the predetermined timeout, it is assumed that a different email message is generating the same checksum. Hence, the start/end date time are updated, the session is re-marked as running and the email message is processed as a new one in the current session.

The message I/O processor 32 may be written in Java (or other suitable programming language) and it is able to access the Oracle™ 34 database 17 where the data is maintained. A JDBC (Java database connectivity) implementation would be a natural way to access the database. JDBC also provides a stateful connection in the program so that row locking may be used to preclude more than one session from processing any email message at the same time. However, JDBC connection raises the issue of password deployment on each server running message I/O processor 32. Hence, another database connection method, namely PL/SQL web services in JDeveloper 10 g may be used to access the database from Java. PL/SQL web services allow for a pre-defined set of stored procedures/functions to be exposed to the http server. Those stored procedures/functions may then be accessed using the http protocol using PL/SQL web stubs, which also written in Java. Since the http protocol is used, database access through PL/SQL web stubs is basically stateless and the semaphore implementation described above has to implement its own state and it also needs to use a timeout to cater for crashed sessions, which are not detectable in a stateless connection.

Thus, while what is shown and described herein constitute preferred embodiments of the subject invention, it should be understood that various changes can be made without departing from the subject invention, the scope of which is defined in the appended claims.

I claim:

1. A method of entering data into a database configured to store a plurality of database records, each record having a set of predetermined data fields, said method comprising the steps of:
(a) creating a data entry message, wherein the data entry message has at least one data segment, each data segment including:
i. a data field identifier corresponding to a data field selected from the set of predetermined data fields; and
ii. a data field entry;
(b) sending the data entry message over a communications network;
(c) receiving the data entry message;
(d) creating a new database record having a plurality of data fields corresponding to the set of predetermined data fields; and
(e) for each data segment, storing the data field entry in a data field corresponding to the data field identifier.

2. The method as claimed in claim 1, further comprising the step of generating a unique object identifier corresponding to the data entry message, and storing the object identifier in the new database record.

3. The method as claimed in claim 2, further comprising the steps of:
(a) creating a further data entry message which includes the object identifier together with additional data;
(b) sending the further data entry message over a communications network;
(c) receiving the further data entry message;
(d) storing the additional data in the new database record.

4. The method as claimed in claim 1, wherein the data entry message comprises an email message.

5. The method as claimed in claim 1, wherein the data entry message further comprises an object type identifier corresponding to an object type.

6. The method as claimed in claim 4, wherein the set of predetermined data fields correspond to the object type.

7. The new database record created pursuant to the method of claim 1.

8. A method of processing a message containing at least one data segment having:
(a) a data field identifier selected from a set of predetermined data fields; and
(b) a data field entry;
said method comprising the steps of:
(c) creating a new database record having a plurality of data fields corresponding to the set of predetermined data fields; and
(d) for each data segment, storing the data field entry in a data field corresponding to the data field identifier.

9. The method of claim 8, further comprising the step of for each data segment, retrieving the data field identifier and the corresponding data entry.

10. A data entry system comprising:
(a) an input device configured to determine a data field identifier and to input a corresponding data field entry;
(b) a message generator operatively coupled to the input device and configured to create a data entry message, wherein the data entry message comprises:
(i) at least one data segment, each data segment including:
I. a data field identifier corresponding to a data field selected from the set of predetermined data fields; and
II. a data field entry;
(c) a message transmitter operatively coupled to and configured to send the data entry message over, a communications network;
(d) a receiver operatively coupled to the communications network and configured to receive the data entry message;
(e) a message manager operatively coupled to the receiver and configured to retrieve from the data entry message the data field identifier and data field entry for each segment;
(f) a database including a new database record having a plurality of data fields corresponding to a set of predetermined data fields; and
(g) a database manager operatively coupled to the message manager and to the database and configured to, for each data segment, store in the database record the data field entry in a data field corresponding to the data field identifier.

11. The system as claimed in claim 10, wherein the data entry message comprises an email message.

12. The system as claimed in claim 10, wherein the data entry message further comprises an object type identifier corresponding to an object type.

13. The system as claimed in claim 12, wherein the set of predetermined data fields correspond to the object type.

14. A data entry system comprising:
(a) a receiver operatively coupled to the communications network and configured to receive a data entry message; and
(b) a message manager operatively coupled to the receiver and configured to detect at least one data field identifier and corresponding data field entry in the data entry message.

15. A data entry system as claimed in claim 11, further comprising:
(a) a database including a new database record having a plurality of data fields corresponding to a set of predetermined data fields; and
(b) a database manager operatively coupled to the message manager and to the database and configured to, for each data segment, storing in the database record the data field entry in a data field corresponding to the data field identifier.
